(19) United States
(12) Patent Application Publication
(10) Pub. No.: US 2021/0250458 A1
(43) Pub. Date: Aug. 12, 2021

(54) CONTROLLING PAPER INTERVAL FOR SCANNING IMAGE

(71) Applicant: HEWLETT-PACKARD DEVELOPMENT COMPANY, L.P., Spring, TX (US)

(72) Inventors: Takuya ITO, Hiratsuka (JP); Jangwon SEO, Suwon (KR); Junghoon LEE, Seongnam (KR); Hojun JANG, Seongnam (KR); Yongkon JO, Suwon (KR); Dusic KONG, Suwon (KR); Yunjeong JEONG, Incheon (KR)

(73) Assignee: HEWLETT-PACKARD DEVELOPMENT COMPANY, L.P., Spring, TX (US)

(21) Appl. No.: 17/049,504

(22) PCT Filed: Mar. 7, 2019
(86) PCT No.: PCT/US2019/021178

§ 371 Date: Oct. 21, 2020

(30) Foreign Application Priority Data
Apr. 27, 2018 (KR) 10-2018-0049364

(51) Int. Cl. H04N 1/00

(52) U.S. Cl. CPC H04N 1/00689; H04N 1/00713; H04N 1/00018; H04N 1/0075; H04N 1/00734

(57) ABSTRACT

An image scanning apparatus includes an image sensor to scan a paper, a paper feeding apparatus to pick up a loaded paper and move the picked-up paper to a paper feeding path, a sensor to output a predetermined signal value when the paper is sensed at a predetermined position in the paper feeding path, and a processor to control the paper feeding apparatus to move the paper depending on a scan command. The processor confirms a length of the paper based on a signal sensed in the sensor, and controls the paper feeding apparatus to pick up the loaded paper based on the confirmed length.

### BACKGROUND

An image scanning apparatus is an apparatus that scans an original image of a document, a picture, a film, or the like, and converts the scanned image into a digital data. In this case, the digital data may be displayed on a monitor of a computer or may be printed by a printer and be created as an output image. An example of such an image scanning apparatus may include a scanner, a copier, a facsimile, a multi-function peripheral (MFP) in which functions of the scanner, the copier, and the facsimile are complexly implemented through one apparatus, or the like.

### BRIEF DESCRIPTION OF THE DRAWINGS

FIG. 1 is a block diagram illustrating simple components of an image scanning apparatus according to an example;

FIG. 2 is a block diagram illustrating detailed components of the image scanning apparatus according to an example;

FIG. 3 is a cross-sectional view schematically illustrating the example image scanning apparatus of FIG. 1;

FIGS. 4A to 4C are example views sequentially illustrating processes of feeding a first paper;

FIGS. 5A to 5D are example views sequentially illustrating processes of feeding a second paper; and

FIGS. 6A to 6E are example views sequentially illustrating processes of feeding papers corresponding to third to n-th papers.

### DETAILED DESCRIPTION

Hereinafter, various examples will be described in detail with reference to the drawings. Example described below may be modified into several different forms. To clearly describe features of the examples, a detailed description for contents well-known with respect to the following examples will be omitted.

Meanwhile, when any component is referred to as being “connected to” another component in the specification, it means that any component and another component are “directly connected to” each other or are “connected to” each other with the other component interposed therebetween. In addition, when any component is referred to as “including” another component, it means the inclusion of other components rather than the exclusion of other components, unless explicitly described to the contrary.

In the specification, an “image forming job” may refer to various jobs (e.g. example, printing, scanning, or faxing) related to an image, such as forming of the image, creating/storing/transmitting of an image file, or the like, and a “job” may refer to the image forming job, as well as a series of processes for performing the image forming job.

In addition, an “image scanning apparatus” refers to an apparatus that scans an image of a paper to create a scan image. An example of such an image scanning apparatus may include a scanner, a copier, a facsimile, a multi-function printer (MFP) in which functions of the scanner, the copier, and the facsimile are complexly implemented through one apparatus, or the like. Meanwhile, in the case in which the image scanning apparatus is the copier, the facsimile, the MFP that may perform the image forming job, the image scanning apparatus may also be called an image forming apparatus.

In addition, the “image forming apparatus” refers to an apparatus that prints a printing data created in a terminal apparatus such as a computer on a recording paper. An example of such an image forming apparatus may include a copier, a printer, a facsimile, an MFP in which functions of the copier, the printer, and the facsimile are complexly implemented through one apparatus, or the like. The image forming apparatus may refer to all apparatuses that may perform the image forming job, such as a printer, a scanner, a fax machine, an MFP, a display apparatus, or the like.

In addition, a “hard copy” may refer to an operation of printing an image on a printing medium such as paper, or the like, and a “soft copy” may refer to an operation of outputting an image on a display apparatus such as a television, a monitor, or the like.

Further, “contents” may refer to all kinds of data that become targets of the image forming job, such as a photograph, an image, a document file, or the like.

Further, “printing data” may refer to a data converted into a format printable in a printer. Meanwhile, when the printer supports direct printing, a file itself may be the printing data.

In addition, “scan data” refers to a scan image created in a scan portion, may be a black and white image or a color image, and may have various types of file formats (for example, BMP, JPG, TIFF, PDF, or the like).

Further, a “user” may refer to a person performing a manipulation related to the image forming job using the image scanning apparatus or using a device connected to the image scanning apparatus in a wired or wireless manner. Further, a “manager” may refer to a person having an authority to access all functions and systems of the image scanning apparatus. The “manager” and the “user” may be the same person.

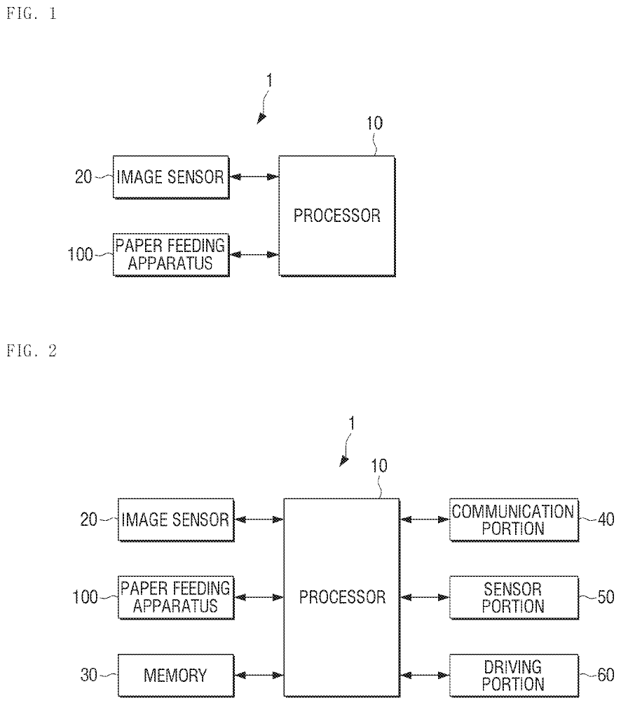

FIG. 1 is a block diagram illustrating simple components of an image scanning apparatus according to an example of the disclosure.

Referring to FIG. 1, an image scanning apparatus 1 may include an image sensor 20, a paper feeding apparatus 100, and a processor 10.

The image sensor 20 scans a paper. In detail, the image sensor 20 may scan image information of the paper from light reflected from the paper. The image sensor 20 may include charge coupled devices (CODs) or a plurality of complementary metal oxide semiconductor (CMOS) image sensors (CISs) disposed in a row in a main scanning direction. The image sensor 20 may be disposed at a lower end of a flatbed, and may be disposed in an automatic document feeder (ADF).

The image sensor 20 may include a conversion circuit converting the scanned signal into a digital signal. In detail, a CCD and a digital CIS outputs the scanned signal as a digital signal, while a CIS outputs the scanned signal as an analog signal. Therefore, in the case in which the image sensor 20 includes the CISs, it may convert the scanned signal into the digital signal, and output the converted digital signal to the processor 10.

The paper feeding apparatus 100 may automatically feed a plurality of papers to the image sensor 20.

In the case in which a paper to be scanned is input to the image scanning apparatus 1, the paper feeding apparatus 100 feeds the input paper to a paper feeding path A by a control of the processor 10.

In detail, the paper feeding apparatus 100 may feed papers input to an input tray 13 of the image scanning apparatus 1 to an output tray 15 through the image sensor 20 along the paper feeding path by a roller driven using at least one motor.

Detailed components of the paper feeding apparatus 10 will be described below with reference to FIG. 3.

The processor 10 controls the respective components in the image scanning apparatus 1. In detail, the processor 10 may be implemented by a central processing unit (CPU), an application-specific integrated circuit (ASIC), or the like, and senses whether or not a scan command is input from a user.

In detail, in the case in which the scan command is input from the user, the processor 100 may control the paper feeding apparatus 100 to feed papers loaded in the paper feeder 13 to the image sensor 20.

The processor 10 may pick up and provide a paper P to the paper feeding path A depending on the scan command. The paper P may be picked up by a pick-up roller 110, and a plurality of papers may be separated and be fed one by one to the paper feeding path A by an ADF roller 130. The separated one paper P may be sensed by a pick-up sensor 51 capable of sensing a feeding situation of the paper.

The processor 10 may stop progress of the paper for a predetermined time in registration rollers 150 to compensate for skew of the paper in a feeding process with respect to the paper passing through the pick-up sensor 51. The processor 10 may rotate the registration rollers 150 by turning on a registration clutch after a predetermined time for aligning the paper elapses. The paper P may be fed to the image sensor 20 by the rotation of the registration rollers 150.

The processor 10 may control a feeding point in time and a feeding speed of the paper.

The registration rollers 150 may be driven by a separate step motor. The processor 10 may confirm a length of the paper through rotation degrees of the registration rollers 150 through a time from a point in time in which a front end of the paper passes through the registration rollers 150 to a point in time in which a rear end of the paper passes through the pick-up sensor 51.

That is, the processor 10 may confirm the length of the paper through a time from a point in time in which the registration clutch is turned on to a point in time in which the pick-up sensor 51 is turned off. An accurate length of the paper may be calculated by a time from a point in time in which the pick-up sensor 51 is turned on to the point in time in which the pick-up sensor 51 is turned off or a time from the point in time in which the registration clutch is turned on to a point in time in which the registration clutch is turned off, but the time from the point in time in which the registration clutch is turned on to the point in time in which the pick-up sensor 51 is turned off is defined as the length of the paper in the disclosure. However, the length of the paper, which is to control a pick-up point in time of the paper, suffices to indicate a predetermined section of the paper.

The processor 10 may confirm a length of a first paper through a time from a point in time in which the registration clutch is turned on to a point in time in which the pick-up sensor 51 is turned off, at the time of feeding the first paper.

The processor 10 may control the pick-up roller 110 to pick up a second paper P₂ when a rear end of the first paper passes through the pick-up sensor 51, such that the pick-up sensor 51 is turned off.

The processor 10 may control the pick-up roller 110 to pick up a third paper P3 when the pick-up sensor 51 is in a turn-on state, which is a state before a rear end of the second paper passes through the pick-up sensor 51. The processor 10 may control the pick-up roller 110 to pick up the third paper P3 at a predetermined point in time before the second paper P₂ passes through the pick-up sensor 51. The processor 10 may control the pick-up roller 110 to pick up the third paper P₃ to a final paper Pₙ loaded in the input tray at a predetermined point in time before the preceding paper Pₙ₋₁ passes through the pick-up sensor 51.

The processor 10 may control the paper feeding apparatus 100 to pick up the third paper P₃ to the final paper Pₙ when a predetermined time elapses after the preceding paper Pₙ₋₁ passes through the registration rollers 150. A control of a paper interval of the paper feeding apparatus 10 for minimizing a paper interval between papers may be performed from the third paper to the final paper.

The processor 10 may confirm the length of the paper by detecting a time in which the front end of the paper P passes through the registration rollers 150 and the rear end of the paper P is not sensed by the pick-up sensor 51, at the time of feeding the paper.

In the case in which it is confirmed that a length of the following paper is longer than that of the preceding paper, the processor 10 may not pick up papers from the following paper in advance at a predetermined point in time. In the case in which the length of the following paper is longer than that of the preceding paper, the processor 10 may recognize that a kind of scanned paper is changed.

In the case in which the length of the following paper is longer than that of the preceding paper, the processor 10 may drive the following paper like the first paper. That is, when the rear end of the preceding paper is not sensed by the pick-up sensor 51, the processor 10 may control the paper feeding apparatus 100 to pick up the following paper.

The paper feeding apparatus 100 according to an example of the disclosure may feed the following paper in advance by a predetermined distance to implement high images per minute (IPMs) even though it uses feeding rollers driven at a speed lower than that of an existing feeding roller. The paper feeding apparatus 100 may control a paper feeding point in time to increase a feeding speed.

The image scanning apparatus 1 according to an example of the disclosure may include the processor 10 for controlling a distance between the papers. The simplest method for increasing a speed of the image scanning apparatus 1 is to increase a processing speed of a scanning job by increasing a speed of a driving motor. However, it is disadvantageous in terms of noise, vibration, and image controls to increase the speed of the scanning job by increasing the speed of the driving motor as described above, such that quality of the image scanning apparatus such as image quality, noise, or the like, is deteriorated.

Therefore, the image scanning apparatus 1 according to an example of the disclosure may increase the speed of the motor by making a distance between the papers as small as possible. The image scanning apparatus 1 may minimize a paper interval as compared with an image scanning apparatus according to the related art to increase the processing speed, resulting in reduction in noise of the image scanning apparatus and improvement of printing image quality.

The image scanning apparatus 1 may short and stably maintain the paper interval between the papers to improve reliability of paper feeding and scan the paper at a high speed without increasing the processing speed, resulting in improvement of a scanning speed and reduction in noise depending on printing.

The processor 10 may start feeding of the paper before the rear end of the paper passes through the pick-up sensor 51. That is, the processor 10 may pick up and feed the following paper to the paper feeding path after a predetermined time elapses, before the rear end of the preceding paper passes through the pick-up sensor 51.

The processor 10 may sense the entire length of the paper, and decide a feeding period of the paper using the sensed length of the paper. The feeding period of the paper may be set to be shorter than the length of the paper.

In addition, in the case in which the fed paper arrives at the image sensor 20, the processor 10 may control the image sensor 20 to perform a scan operation.

Here, in the case in which the scan command input from the user is a single-sided scan command, the processor 10 may control the paper feeding apparatus 100 to output the paper scanned by the image sensor 20 to the outlet tray 15 of the image scanning apparatus 1.

Here, in the case in which the scan command input from the user is a double-sided scan command, the processor 10 may control the paper feeding apparatus 100 to feed the paper scanned by the image sensor 20 to a paper feeding path for double-sided scan.

Meanwhile, the processor 10 may create a control command for a brushless direct current (BLDC) motor operating the paper feeding apparatus 100.

The processor 10 may control the paper feeding apparatus 100 to move the paper depending on the scan command. The processor 10 may first measure a feeding speed of the paper to scan an image from the paper fed through at least one roller.

The feeding speed of the paper may be measured as a revolution per minute (RPM) of the roller rotating by the motor, that is, the number of steps of the motor.

The processor 10 may control the paper feeding apparatus 100 to move the paper depending on the scan command. The processor 10 may confirm the length of the paper on the basis of a signal sensed by a sensor 51, and control the paper feeding apparatus 100 to pick up the loaded paper P on the basis of the confirmed length.

The processor 10 may control the paper feeding apparatus 100 to pick up the next paper in a state in which a predetermined signal value of the sensor 51 is output. The predetermined signal value may be set to a signal value at which the sensor 51 is switched into a turn-off state when the rear end of the paper passes through the sensor 51.

When the predetermined signal value of the sensor 51 is maintained after the next paper is picked up, the processor 10 may allow a separation roller 133 to feed the paper. In this case, the sensor 51 may include a registration sensor 53, and when double feed is sensed by the registration sensor, the separation roller 133 may feed the paper in an opposite direction to a feeding direction.

The processor 10 may confirm the length of the paper on the basis of a time for which the predetermined signal value of the sensor 51 is maintained. When the front end of the paper passes through the sensor 51, the sensor 51 may be switched into a turn-on state, and when the rear end of the paper passes through the sensor 51, the sensor 51 may be switched into the turn-off state. The length of the paper may be confirmed on the basis of the time for which a signal value at which the sensor 51 is in the turn-on state is maintained.

The processor 10 may confirm the length of the paper on the basis of a signal value of a registration sensor 53 and the signal value of the sensor 51. Since the length of the paper is a value for calculating a period for driving the pick-up roller 110 as well as an accurate length of the paper, the length of the paper may be measured on the basis of the registration sensor 53 and the sensor 51. In detail, the length of the paper may be confirmed on the basis of a time from a point in time in which the front end of the paper passes through the registration sensor 53, such that the registration sensor 53 is switched into a turn-on state, to a point in time in which the rear end of the paper passes through the sensor 51, such that the sensor 51 is turned off.

The processor 10 may confirm the length of the paper P depending on an operation time of the registration clutch. The processor 10 may control the paper feeding apparatus 100 to pick up the loaded paper per time unit corresponding to the confirmed length of the paper or a predetermined paper interval. The processor 10 may set the paper interval to 1 to 10 mm during a period in which the paper feeding apparatus 100 feeds the papers at 100 to 150 IPMs.

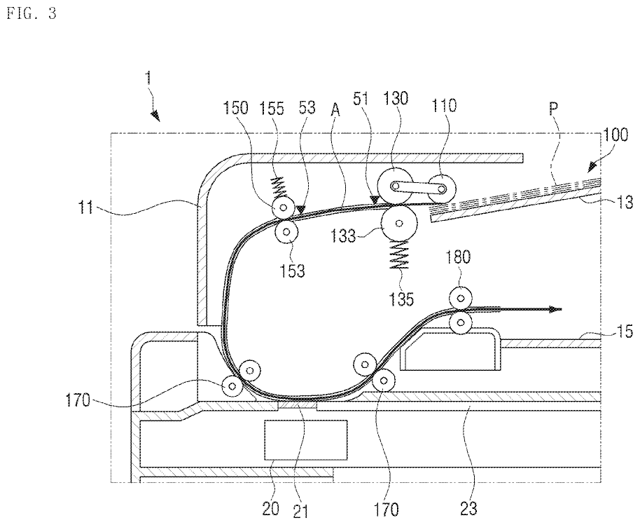

Meanwhile, the simple components of the image scanning apparatus are illustrated and described hereinabove, but various components may be further included in the image scanning apparatus at the time of implementing the image scanning apparatus. Those will be described below with reference to FIG. 2.

FIG. 2 is a block diagram illustrating detailed components of the image scanning apparatus according to an example of the disclosure.

Referring to FIG. 2, the image scanning apparatus 1 may include the image sensor 20, the paper feeding apparatus 100, the processor 10, a memory 30, a communication portion 40, a sensor portion 50, and a driving portion 60.

Operations of the image sensor 20, the paper feeding apparatus 100, and the processor 10 are described with reference to FIG. 1, and an overlapping description therefor will thus be omitted.

The memory 30 may store data for image processing. In detail, the memory 30 may store a program for performing the image processing of the processor 10 or store signals scanned in the image sensor 20 or data processed in the processor 10.

In addition, the memory 30 may store a predetermined paper length (that is, time information corresponding to a front end distance of the paper). The predetermined paper length may be set to be shorter than the measured length of the paper. The processor 10 may pick up the following paper depending on the predetermined paper length stored in the memory 30 before the rear end of the preceding paper passes through the pick-up sensor 51.

Meanwhile, the memory 30 may be implemented by a storage medium in the image scanning apparatus 1 and an external storage medium, for example, a removable disk including a universal serial bus (USB) memory, a storage connected to a host, a web server through a network, or the like.

The communication portion 40 may be connected to a terminal apparatus such as a mobile device (a smartphone or a tablet personal computer (PC)), a PC, a laptop computer, a personal digital assistant (PDA), a digital camera, or the like, and may transmit a scan image or a scan data stored in the memory 30 to the other terminal apparatus. In detail, the communication portion 40 is formed to connect the image scanning apparatus 1 to an external apparatus, and may be connected to the terminal apparatus through a local area network (LAN) and the Internet network or be connected to the terminal apparatus through a USB port or a wireless communication (for example, wireless fidelity (WiFi), 802.11a/b/g/n, near field communication (NFC), or Bluetooth) port.

In addition, in the case in which the image scanning apparatus 1 is an MFP capable of performing a printing job and a copy job, the scan command may be a copy command using a scan function. Meanwhile, the image scanning apparatus 1 may receive the scan command input through a manipulation input portion, but is not limited thereto. That is, the scan command may be received from the terminal apparatus through the communication portion 40.

The driving portion 60 may drive the paper feeding apparatus 100 to feed the paper P.

In the case in which the image scanning apparatus 1 has a form of an automatic feeding apparatus, the driving portion 60 includes a mechanism structure and a motor that may move the paper on a paper feeding path. A form and an operation of the driving portion 60 in the form of the automatic feeding apparatus as described above will be described below with reference to FIG. 3.

Meanwhile, a case in which the driving portion 60 drives the paper feeding apparatus 100 is described hereinabove, but in the case in which the image scanning apparatus 1 is an apparatus having both of a flatbed and an automatic feeding apparatus, the driving portion 60 may include separate driving portions for driving, respectively, the paper feeding apparatus 100 and the image sensor 20.

The sensor portion 50 may include a position sensor sensing the paper. The position sensor may be disposed on the paper feeding path, and may generate a signal when the paper P passes through a predetermined position. The sensor portion 50 may include a pick-up sensor 51 capable of indicating whether or not the paper is normally picked up by sensing the picked-up paper.

The length of the paper may be confirmed through a signal sensed by the pick-up sensor 51, and the processor 10 may control the paper feeding apparatus 100 to pick up the loaded paper P at a predetermined point in time on the basis of the confirmed length of the paper.

In addition, general functions of the image scanning apparatus 1 are illustrated and described in FIGS. 1 and 2, but the image scanning apparatus 1 may further include a fax transmitting/receiving portion performing a fax transmitting/receiving function depending on a function supported by the image scanning apparatus 1 as well as the components described above.

As described above, the image scanning apparatus according to the example may minimize the paper interval between the papers to increase the processing speed, such that high IPMs may be implemented at a low motor speed, noise of the image scanning apparatus may be decreased, and printing image quality may be improved.

FIG. 3 is a cross-sectional view schematically illustrating the example image scanning apparatus of FIG. 1.

Referring to FIG. 3, the paper feeding apparatus 100 may be mounted in the image scanning apparatus, and the image sensor 20 irradiating light to a surface of the paper and creating a digital image from light reflected from the surface of the paper is mounted in a body 11 of the image scanning apparatus 1. The paper feeding apparatus 100 may include the pick-up roller 110, the ADF roller 130, the registration roller 150, feeding rollers 170, and the processor 10.

The image scanning apparatus 1 may include a flatbed form scanning the paper put on a flatbed 23 and an automatic paper feeding form capable of continuously scanning the papers put in the paper feeding apparatus 100.

The image scanning apparatus 1 may include a scan apparatus having the flatbed form, and in the flatbed form, the paper may be put on the flatbed 23, and the image sensor 20 may move below the flatbed 23 on which the paper is put to scan the paper. In this case, the image sensor 20 may move along the flatbed 23 below the flatbed 23.

In the image scanning apparatus 1, which is a scan apparatus having the automatic paper feeding form, the papers are put on the input tray 13, the papers P sequentially move to the paper feeding path A, and when the paper P is positioned in a light window 21, the image sensor 20 scans the paper.

The input tray 13 for loading the papers P to be injected may be positioned on an upper surface of the paper feeding apparatus 100 to load a plurality of papers therein. The pick-up roller 110 for injecting the papers one by one is installed at a position adjacent to the input tray 13. The pick-up roller 110 moves downward toward the paper by the driving portion 60 by a signal of the processor 10 to feed the paper into the image scanning apparatus 1 by frictional force, and double feed of the fed papers may be prevented by the ADF roller 130.

The pick-up roller 110 may separate the papers fed to the input tray 13 one by one and feed the papers one by one to the image sensor 20. The paper feeding apparatus 100 may further include a motor (not illustrated) for driving the pick-up roller 110. Power of the motor may be transferred to the pick-up roller 110 through a plurality of connection gears (not illustrated).

The pick-up roller 110 may pick up a paper on which a target image to be scanned exists. The pick-up sensor 51 may indicate whether or not the paper is normally picked up by sensing the picked-up paper. For example, the pick-up sensor 51 may be positioned in the vicinity of the ADF roller 130.

It may be decided whether or not the paper is normally picked up through whether or not the paper is sensed by the pick-up sensor 51. When the paper is sensed by the pick-up sensor 51, it may be decided that the paper is normally picked up.

The pick-up roller 110 may delay or accelerate a pick-up timing of the paper depending on a state in which the paper is positioned in the pick-up sensor 51 or a time in which the paper arrives at a sensing position of the pick-up sensor 51. The pick-up roller 110 may be driven by a separate step motor (not illustrated). The pick-up roller 110 performs pick-up driving after a predetermined pulses elapses, and is operated by changing a pick-up driving time by the time in which the paper arrives at the sensing position of the pick-up sensor 51.

The paper feeding apparatus 100 according to an example of the disclosure may implement automatic document feeding (ADF) in which a plurality of papers are taken out one by one and are fed to the paper feeding path A. To this end, the paper feeding apparatus 100 may include the ADF roller 130 and the separation roller 133 facing the ADF roller 130.

The ADF roller 130 may feed the paper to the registration rollers 150 along the paper feeding path A. The separation roller 133 may be elastically biased toward the ADF roller 130 by an elastic member 135. The ADF roller 130 and the separation roller 133 may separate the papers one by one using, for example, a difference in frictional force.

In the case in which the plurality of papers are taken in between the ADF roller 130 and the separation roller 133, frictional force between the papers is smaller than that between the ADF roller 130 and the paper and that between the separation roller 133 and the paper. Therefore, a paper in contact with the ADF roller 130 may be separated while the plurality of papers slide with respect to each other, and the paper can then be fed to the paper feeding path A by the feeding rollers 170.

That is, the separation roller 133 disposed on a lower surface of the ADF roller 130 is in contact with the ADF roller 130 while receiving elastic force of the elastic member 135, such that in the case in which the papers are doubly fed, a paper positioned at the uppermost layer is fed due to a difference in frictional force.

The separated paper P passing through the ADF roller 130 is fed to the registration rollers 150, and the registration rollers 150 rotate or stop depending on a driving signal of a controller to feed or temporarily stop the paper, thereby preventing the papers from being fed to the feeding rollers 170 in a duplicate manner.

The registration rollers 150 correct skew of the front end of the paper, and allow the front end of the paper of which the skew is corrected and a front end of an image to coincide with each other. The registration rollers 150 are paper aligning devices preventing the skew of the paper, and may selectively receive driving force of the motor by the registration clutch.

The registration rollers may include an upper registration roller 150 disposed on an upper end of the paper feeding path A and a lower registration roller 153. The upper registration roller 150 is provided with an elastic member 155 applying elastic pressing force toward the lower registration roller 153. The upper registration roller 150 and the lower registration roller 153 may be closely adhered to each other by the elastic member 155.

The image scanning apparatus 1 may stop progress of the paper for a predetermined time in the registration rollers 150 to compensate for skew of the paper in a feeding process with respect to the paper passing through the pick-up sensor 51. The registration rollers 150 may be intermittently operated for a predetermined time through the registration clutch. When the paper feeding apparatus 100 decides that alignment of the paper ends after the predetermined time elapses, the paper feeding apparatus 100 may turn on the registration clutch to rotate the registration rollers 150, and feed the paper P to the image sensor 20 by the feeding rollers 170.

The paper fed by the registration rollers 150 may be fed onto the image sensor 20 by the feeding rollers 170 and then scanned. To obtain a stable image, the feeding rollers 170 may have strong driving force to prevent slip of the paper. When the paper is scanned, the paper moves to the output tray 15 by an output roller 180.

The registration rollers 150 may include a registration sensor 53 sensing the paper to correct the skew of the front end of the paper. As the pick-up sensor 51, the registration sensor 53 may be used. A case in which the paper feeding apparatus 100 according to an example of the disclosure may sense the length of the paper by the pick-up sensor 51 is described, but the disclosure is not limited thereto. That is, the length of the paper may also be sensed using the registration sensor 53.

The registration rollers 150 may feed the paper passing through the pick-up sensor 51 to the image sensor 20. The feeding rollers may be used instead of the registration rollers 150.

The processor 10 may control the paper feeding apparatus 100. In detail, the processor 10 may control the pick-up roller 110 to pick up the paper.

When the paper is normally picked up, the processor 10 may sense the length of the paper through a time from the point in time in which the front end of the paper passes through the registration rollers 150 to the point in time in which a rear end of the paper passes through the pick-up sensor 51. The processor 10 may confirm the sensed length of the paper, and control a pick-up point in time of the following paper so that an interval between the papers corresponds to a predetermined interval. That is, the processor 10 may control the paper feeding apparatus 100 to pick up the following paper Pₙ after the preceding paper Pₙ₋₁ is fed for a predetermined time.

The feeding rollers 170 may be provided as a pair, and serve to feed the paper P picked up by the pick-up roller 110 to the image sensor at a predetermined speed while facing each other and rotating in one direction. The feeding rollers 170 may simultaneously rotate at the same speed by receiving power of a motor of the driving portion 60.

The motor driving the pick-up roller 110 and the motor driving the feeding rollers 170 may be controlled to be independently driven by the processor 10.

The processor 10 may drive the pick-up roller 110 to pick up the first paper P₁ depending on the scan command.

The processor 10 may drive the pick-up roller 110 on the basis of the signal sensed in the pick-up sensor 51 with respect to the second paper P₂. In detail, the processor 10 may control the pick-up roller 110 to rotate toward the paper P to pick up the second paper P₂ when the rear end of the first paper P₁ passes through the pick-up sensor 51, such that the pick-up sensor 51 is turned off.

The processor 10 may rotate the pick-up roller 110 toward the paper P to pick up the following paper when a predetermined time elapses, regardless of the signal sensed in the pick-up sensor 51, with respect to papers from the third paper P₃ onward. In detail, the processor 10 may perform a control to pick up a fourth paper P₄ depending on the predetermined time even in a state in which a rear end of the third paper P₃ does not pass through the pick-up sensor 51. The interval between the papers may be minimized and the IPMs may be efficiently increased regardless of a speed of the motor, by such a processor 10.

A case in which the number of paper feeding paths is one is illustrated in FIG. 3, but the number of paper feeding paths is not limited. That is, the paper feeding apparatus 100 may include two paper feeding paths. That is, the paper feeding apparatus 100 may include a paper feeding path for single-sided scan and a paper feeding path for double-sided scan.

Hereinafter, a method of feeding a paper according to an example of the disclosure using the image scanning apparatus having the configuration as described above will be described in detail.

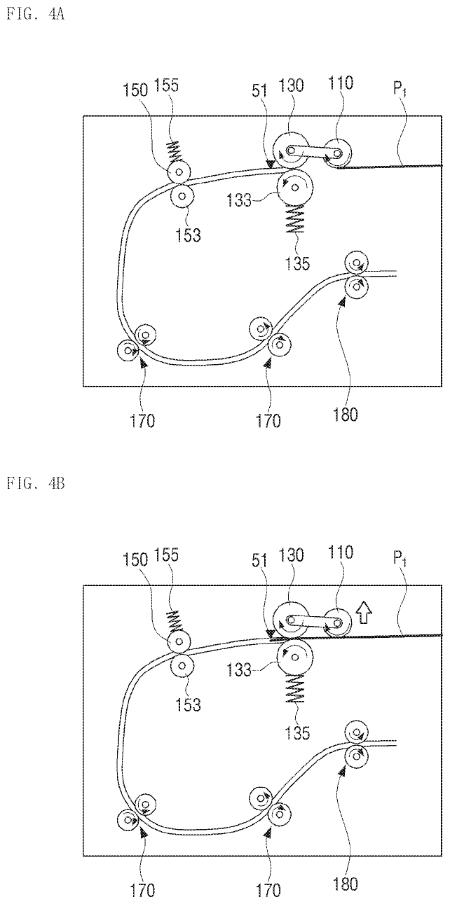

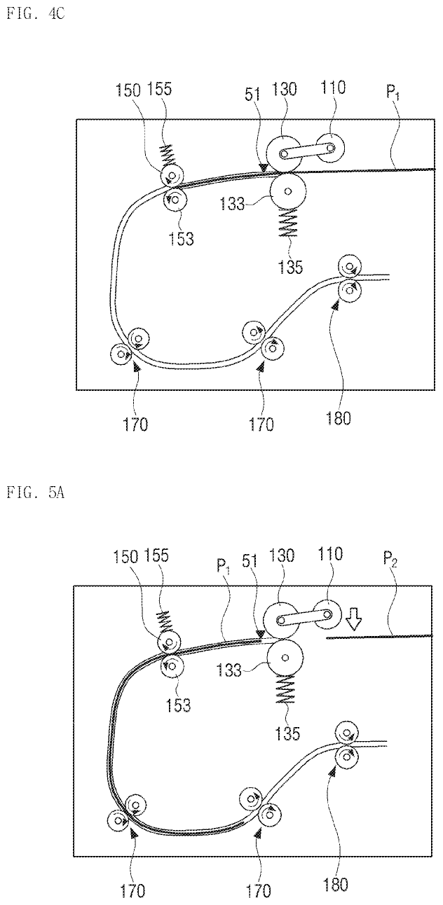

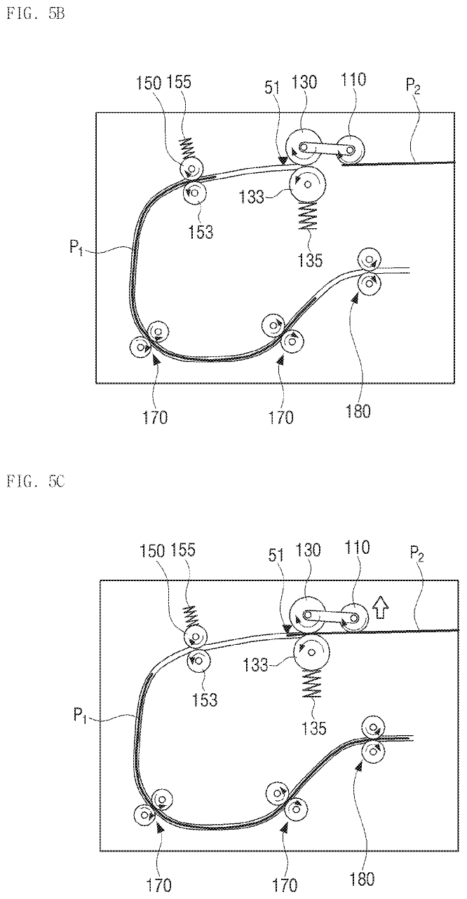

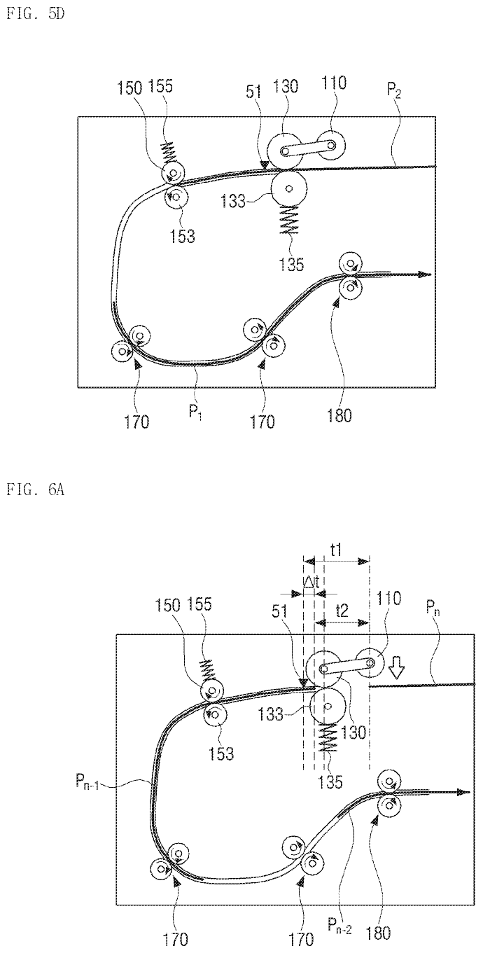

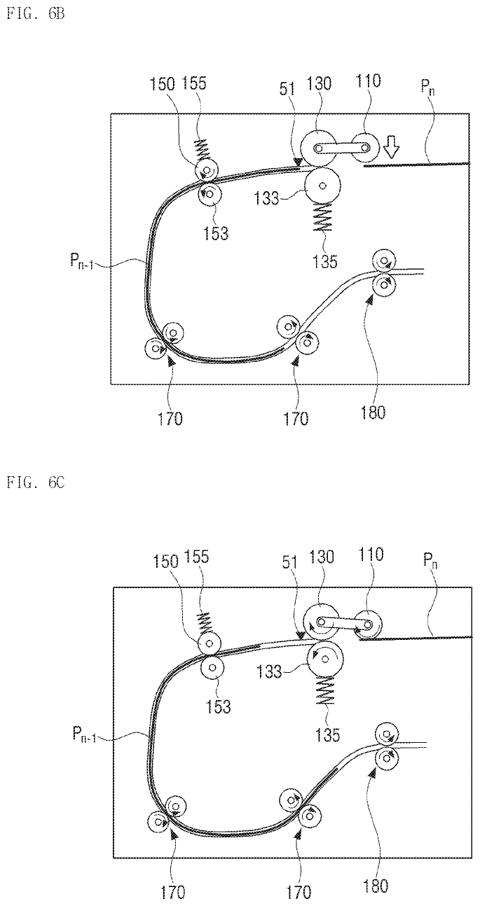

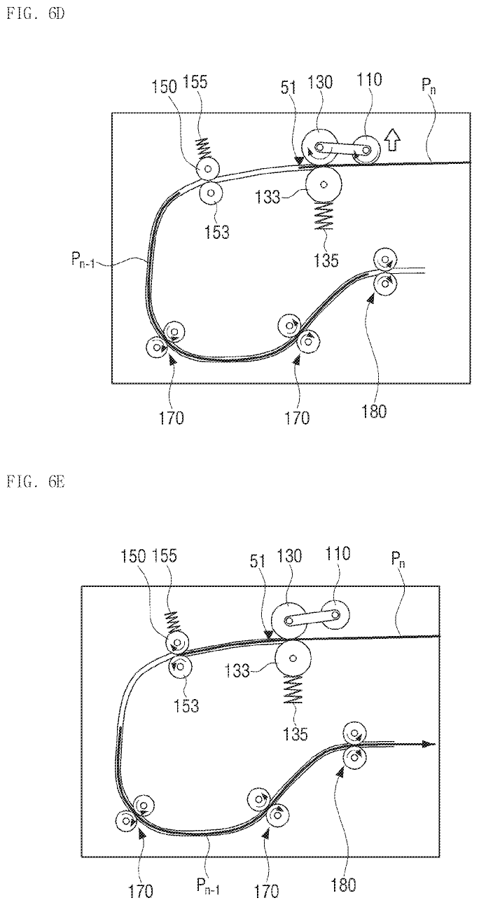

FIGS. 4A to 4C are views sequentially illustrating processes of feeding a first paper, and FIGS. 5A to 5D are views sequentially illustrating processes of feeding a second paper. In addition, FIGS. 6A to 6E are views sequentially illustrating processes of feeding papers corresponding to third to n-th papers.

Processes of feeding a first paper of papers for scanning will be described with reference to FIGS. 4A to 4C.

A length of the first paper may be sensed by confirming a time from a point in time in which a front end of the first paper P₁ starts between registration rollers 150 to a point in time in which a rear end of the first paper P₁ arrives at the pick-up sensor 51 for a period in which the first paper is fed.

An operation of controlling a paper interval between papers according to the disclosure is performed by whether or not the paper is sensed by the pick-up sensor 51 sensing the paper and a predetermined time in which the paper arrives so that the papers have a predetermined paper interval therebetween.

Papers to be scanned are loaded in the input tray, and the first paper P₁ is positioned in an initial state. The paper may be fed onto the paper feeding path A by the pick-up roller 110 and the ADF roller 130 while the scan is performed depending on the scan command.

When the front end of the picked-up first paper Pi arrives at a position at which it is sensed by the pick-up sensor 51, the pick-up sensor 51 is switched into a turn-on state. When the paper is sensed by the pick-up sensor 51, the pick-up roller 110 ascends. In the case in which double feed occurs depending on the ascent of the pick-up roller 110, some of the doubly fed papers may be fed reversely to the input tray 13 by the separation roller 133.

After the front end of the first paper P₁ arrives at the registration rollers 150, the skew of the front end of the first paper P₁ may be corrected, and the first paper P₁ of which the skew of the front end is corrected may be fed to the image sensor 20. The paper feeding apparatus 100 may sense a length of the first paper P₁ through a time from a point in time in which the first paper P₁ passes through the registration rollers 150 to a point in time in which the rear end of the first paper P₁ is not sensed in the pick-up sensor 51.

Processes of feeding a second paper of the papers for scanning will be described with reference to FIGS. 5A to 5D.

When the rear end of the first paper P₁ passes through the pick-up sensor 51, the second paper P₂ may be picked up. In detail, when the rear end of the first paper P₁ is not sensed by the pick-up sensor 51, the pick-up roller 110 may descend to pick up the second paper P₂. A paper interval between the second paper P₂ picked up as described above and the first paper P₁ is in a state in which it is not controlled according to an example of the disclosure. To decide a kind of paper, the paper feeding apparatus 100 may not apply the control of the paper interval to the first paper P₁ and the second paper P₂.

When a front end of the picked-up second paper P₂ arrives at a position at which it is sensed by the pick-up sensor 51, the pick-up sensor 51 is switched into a turn-on state. When the paper is sensed by the pick-up sensor 51, the pick-up roller 110 ascends. In the case in which double feed occurs depending on the ascent of the pick-up roller 110, some of the doubly fed papers may be fed reversely to the input tray 13 by the separation roller 133.

A length of the second paper P₂ may be confirmed through a time from a point in time in which the front end of the second paper P₂ starts from a nib formed between the registration rollers 150 to a point in time in which a rear end of the second paper P₂ arrives at the pick-up sensor 51.

Example processes of feeding a third paper of the papers for scanning will be described with reference to FIGS. 6A to 6E.

A paper interval between papers may be controlled so that the third to final papers (Pn) (here, n is three or more) have a predetermined paper interval therebetween. Referring to FIG. 6A, the third paper P₃ may be picked up depending on a predetermined time before the rear end of the second paper P₂ passes through the pick-up sensor 51.

When the rear end of the first paper P₁ arrives at the pick-up sensor 51, the second paper P₂ may be picked up. Therefore, a paper interval between the first paper P₁ and the second paper P₂ may be determined to be a distance t1 from the pick-up sensor 51 to the pick-up roller 110.

In the case of papers from the third paper P₃ onward, when the preceding paper Pₙ₋₁ is fed by a predetermined time, the following paper Pₙ may be picked up regardless of whether a rear end of the preceding paper Pₙ₋₁ passes through the pick-up sensor 51. Therefore, a paper interval t2 between the paper Pₙ₋₁ and the paper Pₙ from the third paper may be formed to be shorter than the paper interval t1 between the first paper P₁ and the second paper P₂.

When a predetermined time elapses after the second paper P₂ passes through the registration rollers 150, the third paper P₃ may be picked up. When the third paper P₃ is picked up, the rear end of the preceding second paper P₂ may be positioned at the rear end of the pick-up sensor 51.

A paper interval t2 between an n-1-th paper Pₙ₋₁ and an n-th paper Pₙ may be formed to be shorter than the paper interval t1 between the first paper P₁ and the second paper P₂ by a distance Δt between a rear end of the n-1-th paper Pₙ₋₁ and the pick-up sensor 51. The paper feeding apparatus 100 may minimize a paper interval by controlling a pick-up time of the paper so the papers Pₙ after the third paper have a predetermined paper interval therebetween.

When a speed of the image scanning apparatus according to the disclosure is increased, paper feeding quality may be improved. To this end, the paper interval between the papers may be minimized, and the minimized paper interval may be stably maintained. To maintain such a paper interval, the pick-up sensor capable of sensing a position of the front end of the paper may be disposed, and a pick-up timing may be controlled in association with the pick-up sensor to increase the IPMs.

The paper feeding apparatus 100 according to an example of the disclosure may feed the papers at 100 to 150 IPMs. In this case, the predetermined paper interval may be set to 1 to 10 mm. In detail, the paper feeding apparatus 100 may feed the papers at IPMs up to 150 IPMs. In this case, the predetermined paper interval may be set to 5 mm.

When it is sensed that the preceding paper is fed from the registration rollers 150 for a predetermined time, the processor 10 may control the pick-up roller 110 to pick up the following paper. The image scanning apparatus 1 may minimize the paper interval between the papers as compared with a case of picking up the paper depending on a position of the paper sensed by the pick-up sensor 51.

Therefore, in an image scanning method according to the example, the IPMs may be efficiently increased by picking up the following paper in advance to perform a control so that the paper interval between the papers is a predetermined distance. The image scanning method according to the example may be executed on the image scanning apparatus having the components of FIG. 1 or FIG. 2 or may be executed on an image scanning apparatus or a scan apparatus having other components.

Meanwhile, the image scanning method according to the example described above may be implemented by a program and be provided to the image scanning apparatus. For example, a program including the image scanning method may be stored and provided in a non-transitory computer readable medium.

Although examples of the disclosure have been illustrated and described hereinabove, the disclosure is not limited thereto, but may be variously modified without departing from the spirit and scope of the disclosure as claimed in the claims. These modifications are to fall within the scope of the disclosure.

What is claimed is:

1. An image scanning apparatus, comprising:
a tray;
an image sensor;
a paper feeding apparatus to pick up a printing medium loaded in the tray and move the printing medium to a paper feeding path;
a sensor to output a predetermined signal value based on whether the printing medium is sensed at a predetermined position in the paper feeding path; and
a processor to control the paper feeding apparatus to move the printing medium based on a scan command to scan the printing medium by the image sensor, to determine a length of the printing medium based on the predetermined signal value output by the sensor, and to control the paper feeding apparatus to pick up a next printing medium loaded in the tray based on the determined length.

2. The image scanning apparatus as claimed in claim 1, wherein
the sensor is positioned adjacent to a pick-up roller, and
the processor is to control the paper feeding apparatus to pick up the next printing medium in a state in which the sensor outputs the predetermined signal value.

3. The image scanning apparatus as claimed in claim 2, wherein
the paper feeding apparatus includes a separation roller, and
the processor is to allow the separation roller to feed the printing medium when the predetermined signal value output by the sensor is maintained after the next printing medium is picked up.

4. The image scanning apparatus as claimed in claim 1, wherein the processor is to determine the length of the printing medium based on a time for which the predetermined signal value of the sensor is maintained.

5. The image scanning apparatus as claimed in claim 1, further comprising:
a registration sensor to sense skew of the printing medium,
wherein the processor is to determine the length of the printing medium based on a signal value of the registration sensor and a signal value of the sensor.

6. The image scanning apparatus as claimed in claim 1, further comprising:
a registration clutch to selectively provide power to a registration roller to correct skew,
wherein the processor is to determine the length of the printing medium based on an operation time of the registration clutch.

7. The image scanning apparatus as claimed in claim 1, wherein the processor is to control the paper feeding apparatus to pick up a further printing medium loaded in the tray which follows the next printing medium per time unit corresponding to the determined length of the printing medium or a predetermined paper interval.

8. The image scanning apparatus as claimed in claim 7, wherein the predetermined paper interval is 1 to 10 mm, during a period in which the paper feeding apparatus is to feed printing media at 100 to 150 images per minute (IPMs).

9. The image scanning apparatus as claimed in claim 1, wherein the processor is to determine a length of each printing medium picked up by the paper feeding apparatus.

10. A non-transitory machine-readable storage medium encoded with instructions executable by a processor, the non-transitory machine-readable storage medium comprising:
instructions to pick up a printing medium loaded in a tray of an image scanning apparatus and to move the printing medium to a paper feeding path;
instructions to output a predetermined signal value when the printing medium is sensed by a sensor at a predetermined position in the paper feeding path;
instructions to determine a length of the printing medium based on the predetermined signal value output by the sensor;
instructions to pick up a next printing medium loaded in the tray based on the determined length and to move the next printing medium to the paper feeding path; and
instructions to create a scan image by scanning the printing medium.

11. The non-transitory machine-readable storage medium as claimed in claim 10, wherein the instructions to pick up the next printing medium include picking up the next printing medium in a state in which the sensor outputs the predetermined signal value.

12. The non-transitory machine-readable storage medium as claimed in claim 10, wherein the instructions to determine the length of the printing medium are based on a time for which the predetermined signal value output by the sensor is maintained.

13. The non-transitory machine-readable storage medium as claimed in claim 10, wherein the instructions to pick up a further printing medium loaded in the tray which follows the next printing medium include picking up the further printing medium per time unit corresponding to the determined length of the printing medium or a predetermined paper interval.

14. The non-transitory machine-readable storage medium as claimed in claim 13, wherein the instructions to move the further printing medium include setting the predetermined paper interval to 1 to 10 mm, during a period in which printing media are fed at 100 to 150 images per minute (IPMs).

15. The non-transitory machine-readable storage medium as claimed in claim 10, further comprising instructions to determine the length of each printing medium picked up by the paper feeding apparatus.
